(19) United States
(12) Patent Application Publication
(10) Pub. No.: US 2009/0277012 A1
(43) Pub. Date: Nov. 12, 2009

(54) HAIR TRIMMER WITH SUCTION UNIT

(75) Inventors: Chirstian Mikula, Wernberg (AT); Gerald Kauer, Ferlach (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,601

(22) PCT Filed: Sep. 13, 2007
(86) PCT No.: PCT/IB07/53690

§ 371 Date: Mar. 10, 2009

(30) Foreign Application Priority Data
Sep. 15, 2006 (EP) 06120736.1

(51) Int. Cl. B26B 19/44

(52) U.S. Cl. 30/41.6

(57) ABSTRACT

To improve the ease of use, a hair trimmer (1) is proposed, this hair trimmer (1) comprising a cutting unit (2) for trimming hair driven by a first motor (20) and a suction unit (3) for absorbing clippings that is driven by a second motor (30), wherein the second motor (30) is operable to function in at least two different modes, one of the modes resulting in a lower suction power and the other of the modes resulting in a higher suction power.

### FIELD OF THE INVENTION

The present invention relates to a hair trimmer comprising a cutting unit for trimming hair driven by a first motor and a suction unit for absorbing clippings that is driven by a second motor.

### BACKGROUND OF THE INVENTION

A hair trimmer usually has a cutting unit with two blades moved relatively to one another with help of a motor. The cutting unit is normally mounted on a casing of the hair-cutting apparatus housing the motor and eventually batteries as power supply for the cutting unit, wherein the casing also serves as handle for hand-held hair-trimming systems.

The hairs to be cut are caught between the teeth of the blades and severed due to the reciprocating movement of the blades. Usually, only one of the blades is reciprocating while the other one is stationary. For safety reasons, the stationary blade is often chosen to be next to the skin with hair to be cut, thus shielding the skin from the reciprocating blade to avoid injuries.

The cut hair or clipping would usually fall down and soil the object of the trimming, the trimmer and the surrounding room. To avoid this nuisance, trimmers with a suction system to suck and collect the clipping are commercially available.

One example of a beard trimmer with an internal vacuum powered suction unit is disclosed in US 2002/0108255 A1. The disclosed beard trimmer has an internal vacuum system that collects the hair clippings generated by the trimmer during grooming. The beard trimmer is comprised of two main mechanisms, a beard trimmer and a vacuum powered suction unit. The beard trimmer with internal vacuum is comprised of an external body, which houses a motor, wiring, and a power source. Additionally, the beard trimmer casing also houses the vacuum powered suction unit. The beard trimmer also includes of a pair of reciprocating cutting blades and an electric motor that drives the blades. The vacuum powered suction unit includes an air intake, a filter unit, a hamster cage or turbine style impeller, a filter unit housing, and at least one external exhaust port. The suction unit is designed to capture the clippings created by the blades during grooming.

It is an object of the present invention to further improve the ease of use of the trimmers with a suction unit of the state of the art.

### SUMMARY OF THE INVENTION

This object is achieved by a hair trimmer comprising a cutting unit for trimming hair driven by a first motor and a suction unit for absorbing clippings that is driven by a second motor, wherein the second motor is operable to function in at least two different modes, one of the modes resulting in a lower suction power and the other of the modes resulting in a higher suction power.

Such a hair trimmer having two different motors, one for the cutting unit and one for the suction unit, allows to choose different driving modes for the suction unit independently from the operation of the cutting unit. The different driving modes for the suction unit have the important advantage to allow for different suction power to be chosen from the user of the hair trimmer adapted to the length, thickness and number of the clippings to be collected. Thus, an efficient collection of clippings is ensured in all situations.

Higher suction power has usually the consequence of higher energy consumption and sometimes other nuisances like higher noise. The possibility of choosing a higher suction power only, when it is actually needed, has the advantage of allowing a minimization of energy consumption and of noise despite of providing the necessary suction power.

It will be noted that the hair trimmer may be used on any kind of hair, be it human or animal, capillary, beard, pubic or other.

In preferred embodiments of the present invention, the suction unit comprises a fan that is driven by the second motor. The fan transports air, thus generating a vacuum to suck the clippings together with the air taken in by the fan. A suction unit based on a fan has the advantage to be comparatively inexpensive. It does not need too much space and is therefore simply implemented inside a hair trimmer.

Advantageously, the second motor is operable at different values of revolutions per minute. By operating the motor of the suction unit at different values of revolution, different suction powers can be achieved. Particularly in the case of a suction system based on a fan, the speed of the fan is increased by higher values of revolutions per minute of the driving motor. The higher the speed of the fan, the higher is the resulting suction power.

In a preferred embodiment of the present invention, the suction unit comprises two radial fans that are driven by the second motor. This embodiment provides the advantage of making possible to arrange for a certain geometric disposition of the suction power by having two suction streams. This allows further improving the efficiency of sucking and collecting the clippings.

The hair trimmer preferably comprises a receptacle to collect hair clippings, this receptacle being arranged in suction direction before the fan. As the hair clippings do not reach the fan, less maintenance of the fan is necessary, thus improving the ease-of-use and the lifetime of the hair trimmer.

### BRIEF DESCRIPTION OF THE DRAWINGS

A detailed description of the invention is provided below. Said description is provided by way of a non-limiting example to be read with reference to the attached drawings in which:

FIG. 1 illustrates a first embodiment of a beard trimmer;

FIG. 2 illustrates a second embodiment of a beard trimmer;

FIG. 3 illustrates an example for a radial fan;

FIG. 4a illustrates a third embodiment of a beard trimmer in a cut view;

FIG. 4b illustrates the third embodiment of the beard trimmer in a three-dimensional view; and

FIG. 5 illustrates a further example of a beard trimmer.

### DETAILED DESCRIPTION OF THE INVENTION

The present invention will be explained more in detail with respect to a beard trimmer 1. But it will be noticed that the present invention may as well be implemented in any device designed for cutting or trimming, such as e.g. clippers or shavers.

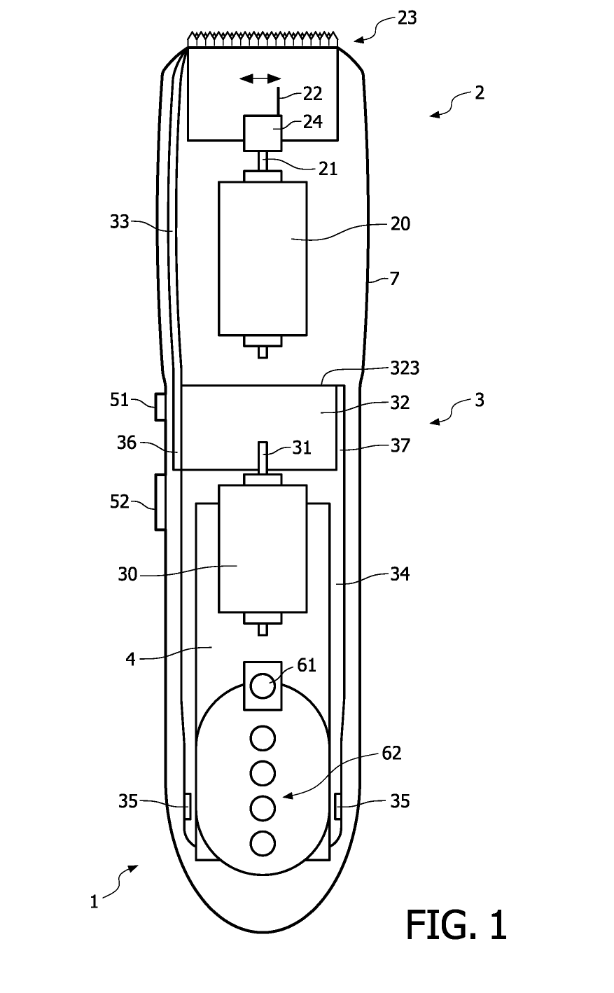

FIG. 1 shows schematically a first embodiment of a beard trimmer 1 comprising a cutting unit 2 and a suction unit 3, both housed in a casing 7. The main components of the cutting unit 2 are an electric motor 20 driving in well-known fashion reciprocating blades 23 with the help of a spindle 21, a gearing 24 and a shaft 22. The direction of the reciprocating movement is indicated by the double arrow.

The electric motor 20 is powered by a reloadable battery 4 and can be switched on or off by pressing the switch 51. The lamp 61 indicates whether the electric motor 20 is switched on or not.

As is well known by the person skilled in the art, one of the blades 23 is stationary and the other of the blades 23 is moving in a reciprocating manner with respect to the stationary blade. Both blades 23 are toothed, such that the hair to be trimmed is caught by the stationary blade like by a comb and than severed by the moving teeth of the reciprocating blade. The cut hair or clippings are absorbed by the suction unit 3 before they soil the immediate environment.

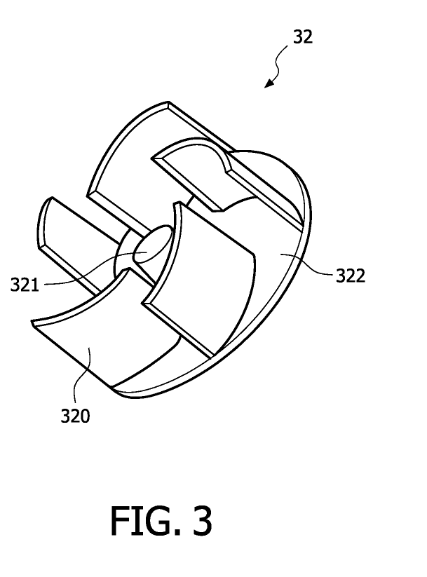

To this end, the suction unit 3 comprises an air intake 33 starting next to the blades 23 and leading air and eventually clippings to the fan 32. The fan 32 is a radial fan, the inner design of which is illustrated in FIG. 3. The fan 32 includes curved vanes 320 that are encapsulated by a bottom plate 322, a top plate 323 (see FIG. 1) and sidewalls (not shown) with an opening for the air/clipping input 36 and an opening for an air/clipping output 37 to the receptacle 34 for collecting the clippings. By rotating the fan 32 around its axis and thus moving the vanes 320, air and eventually clippings are transported in radial direction of the fan 32 from outside through the air intake 33 to the receptacle 34, where clippings are collected.

It will be noted that any other kind of fan, in particular an axial fan can be used as well.

The air sucked into the receptacle 34 can exit it through filters 35 that ensure that the clippings are retained inside the receptacle 34. In less sophisticated embodiments, the slits between the receptacle 34 and the other components inside the casing 7 as well the adjacent parts of the casing can have the function of the filters 35. The receptacle 34 is removable from the casing 7 to empty it. The level of plentiness can be shown with a dedicated indicator. Another possibility is to choose a transparent material for the receptacle 34. Then the user can see, whether the receptacle 34 needs to be emptied.

The fan 32 is rotated thanks to an electric motor 30 with the help of a spindle 31. The fan 32 has an adaptor 321 (see FIG. 3) to be coupled with the spindle 31. The motor 30 is powered by the reloadable battery 4 like the motor 20 of the cutting unit 2 and can be switched by shifting the switch 52 into different positions. Each position represents a definite value of revolutions per minutes of the motor 30, respectively of the fan 32 and is indicated by one or more of the lamps 62 being on or not.

Depending on the dimensions of the fan 32 and the revolutions per minute the volume per time unit transported by the fan 32, i.e. the suction power varies. The ratio of the volumes per time unit is equal to the ration of the revolutions per minute. For example, a trimmer according to the embodiment shown in FIG. 1 with a fan like shown in FIG. 3 and having a diameter of 36 mm could achieve a volume of sucked air of around 1 liter per second for ca. 6500 revolutions per minute of the motor 30 and the fan 32 and of 1.25 liters per second for ca. 8000 revolutions per minute. Tests have shown that the suction power can be increased without apparent limit by increasing the value of revolutions per minute, whereas the cutting performance can be increased only up to a certain level by increasing the value of revolutions per minute. If the value is too high, i.e. the reciprocating blade moves too fast, more hairs are pushed outside the blade teeth than are being cut.

In case of the illustrative beard trimmer with a fan 32 having a diameter of 36 mm, the maximum possible value of revolutions per minutes ensuring an acceptable cutting performance is around 9000 revolutions per minute. With increasing revolutions per minute, not only the energy consumption, but also the generated noise increases. In view not only of a good cutting performance, but also of a moderate energy consumption as well as of avoidance of too much noise, in case of said illustrative beard trimmer, a value of around 6500 revolutions per minutes is preferred for the motor 20 of the cutting unit 2, whereas for the motor 30 of the suction unit 3 the default value for the revolutions per minute is around 6500 revolutions per minute as well, when switching the suction unit 3 on. But the suction motor 30 can be switched up to higher values, e.g. 7500, 8500 and 9500 revolutions per minute, to increase the suction power. In case of a similar illustrative beard trimmer having only a lower and a higher suction power mode, the lower mode could be chosen around for example 6500 revolutions per minute and the higher mode for better suction around for example 8000 revolutions per minute.

It will be noted that the desired values of the revolutions per minutes depend on the dimensions of the respective trimmer, in particular of the dimensions of the fan and the air intake as well as the motor.

A beard trimmer 1 having two different motors 20, 30, one for the cutting unit 2 and one for the suction unit 3, allows to choose different driving modes for the suction unit 3 independently from the operation of the cutting unit 2. The different driving modes for the suction unit 3 have the important advantage to allow for different suction power to be chosen from the user of the beard trimmer 1 adapted to the length, thickness and number of the clippings to be collected. Thus, an efficient collection of clippings is ensured in all situations.

Higher suction power has usually the consequence of higher energy consumption and sometimes other nuisances like higher noise. The possibility of choosing a higher suction power only, when it is actually needed, has the advantage of allowing a minimization of energy consumption and of noise despite providing the necessary suction power.

Having two different motors 20, 30 is especially advantageous in view of noise, because the cutting unit 2 is usually louder than the suction unit 3 for the same value of revolutions per minute. Thus, it is possible to provide a higher suction power with less noise compared with trimmers having only one motor driving the cutting unit 2 as well as the suction unit 3. Nonetheless, it will be noted that the possibility to regulate the suction power in function of the actual trimming situation is a substantial improvement of trimmers with only one motor for cutting unit and suction unit, too.

It will further be noted that the presently described embodiments allow for additional comb units to regulate the trimmings length, as is well known to the person skilled in the art.

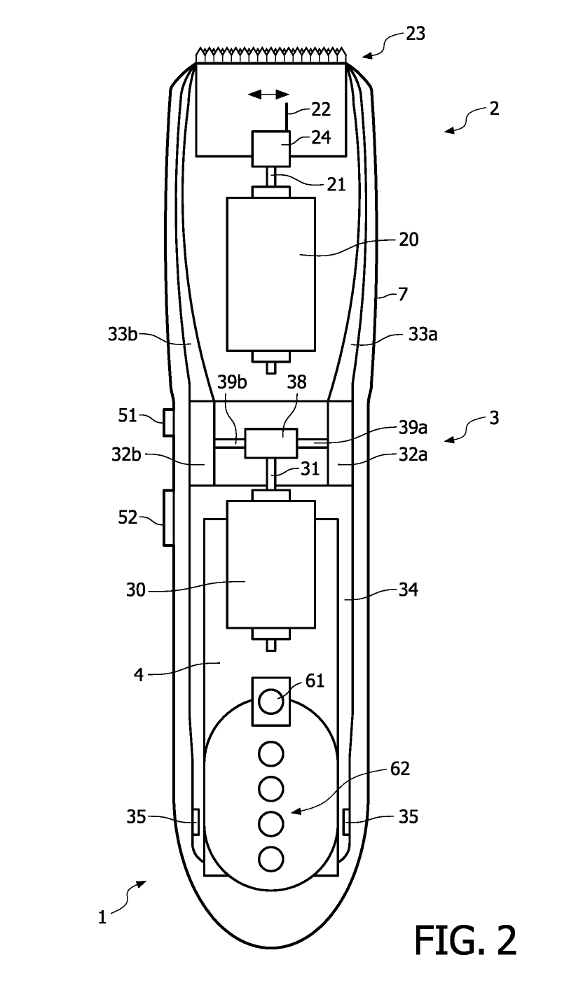

FIG. 2 schematically illustrates an embodiment of a beard trimmer with two radial fans 32a, 32b. Both fans 32a, 32b are driven by the motor 30 by way of the spindle 31, the gearing 38 and the spindles 39a, 39b. Each fan 32a, 32b has its dedicated air intake 33a, 33b. The air intakes 33a, 33b are arranged to take air in and suck in hair clippings at each side of the blades 23 to make the suction of the clippings more efficient. Both fans 32a, 32b exhaust the air and the clippings into the common receptacle 34 for collecting the clippings.

It will be noted that the air intakes could be arranged in other ways, too, depending on the suction geometry one wants to achieve to improve clipping suction. As well, more than two fans could be used, too, e.g. three, four, five fans, and depending on the dimensions of the trimmer and the suction power values needed, the fans can be driven by individual motors, too.

In embodiments like illustrated in FIG. 2, it can be advantageous to have two motors driving each one fan to be able to regulate the suction power of the one fan independently of the other fan, for example in case of hair trimmers used to trim scalp hair depending on whether one is trimming hair around the right side ear or the left side ear.

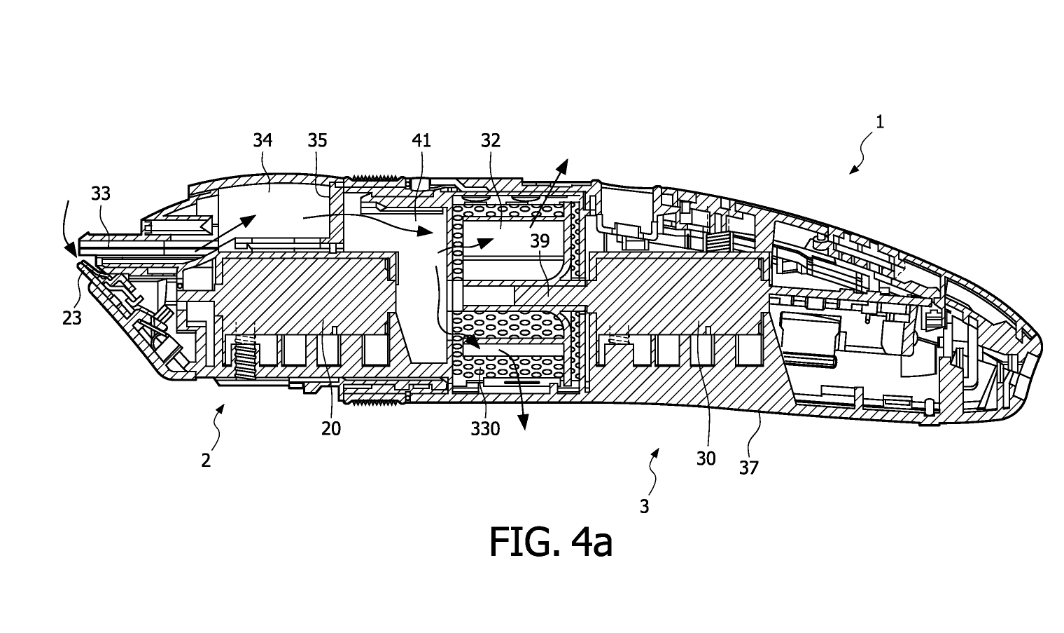

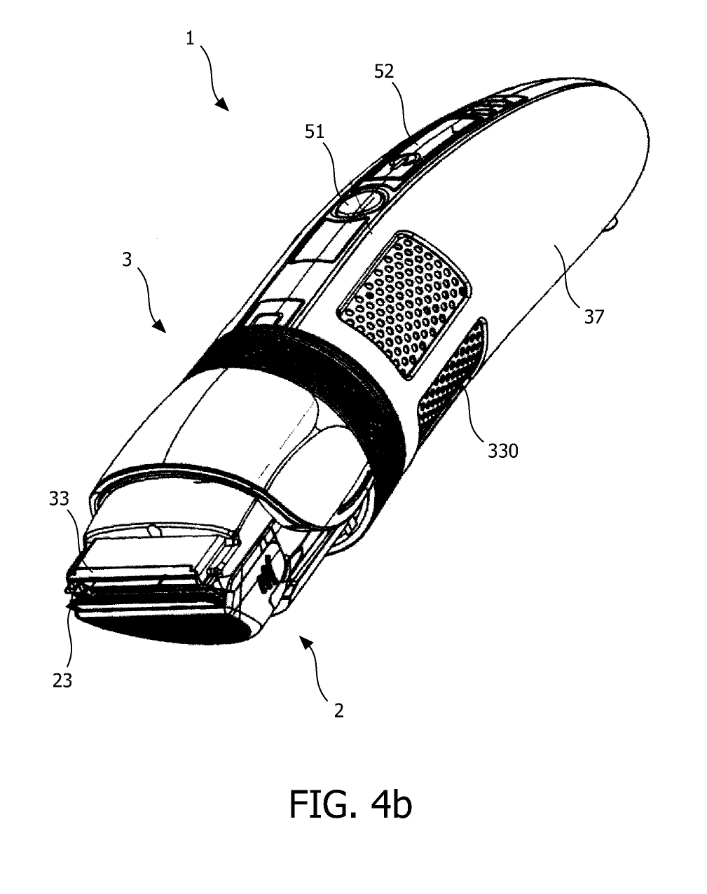

FIG. 4a shows schematically a cut view of a further embodiment of a beard trimmer 1. The beard trimmer 1 illustrated in FIG. 4a is different from the previous ones in that the receptacle 34 for collecting the hair clippings is arranged in suction direction before the fan 32.

The suction direction is indicated by the arrows illustrating the way of the sucked air through the beard trimmer 1: the air is sucked in immediately next to the blades 23, where the hair clippings occur. As can be seen from the three-dimensional view of the beard trimmer 1 in FIG. 4b, the air intake 33 is elongated and parallel to the blades 33 to optimally suck in a maximum of hair clippings. The hair clippings are immediately led into the receptacle 34 (see FIG. 4a) next to the motor 20 driving the blades 23. There, the hair clippings are collected, while the air passes through the filter 35 into an intermediate chamber 41 before entering the fan 32 itself, which is driven by the motor 30 via the spindle 39, and exiting the casing 37 of the beard trimmer 1 through the air exhaust 330. In the present example, the exhaust 330 is formed by the housing of the fan 32 providing a multitude of holes (see also FIG. 4b). The motor 30 is arranged to run with different speeds to provide rotation of the fan at different velocities, thus ensuring different suction powers to be chosen by the user.

The present arrangement of the receptacle 34 before the fan 32 has several advantages. Besides preventing soiling the fan 32 with hair clippings, it allows for an easily removable receptacle 32 that needs minimum of space. It further allows an enlargement of the air intake 33. This is enhanced by the intermediate chamber 41 providing an even larger area to be flown through by the air. This largely improves the suction power of the fan 32, because the flow resistance is reduced.

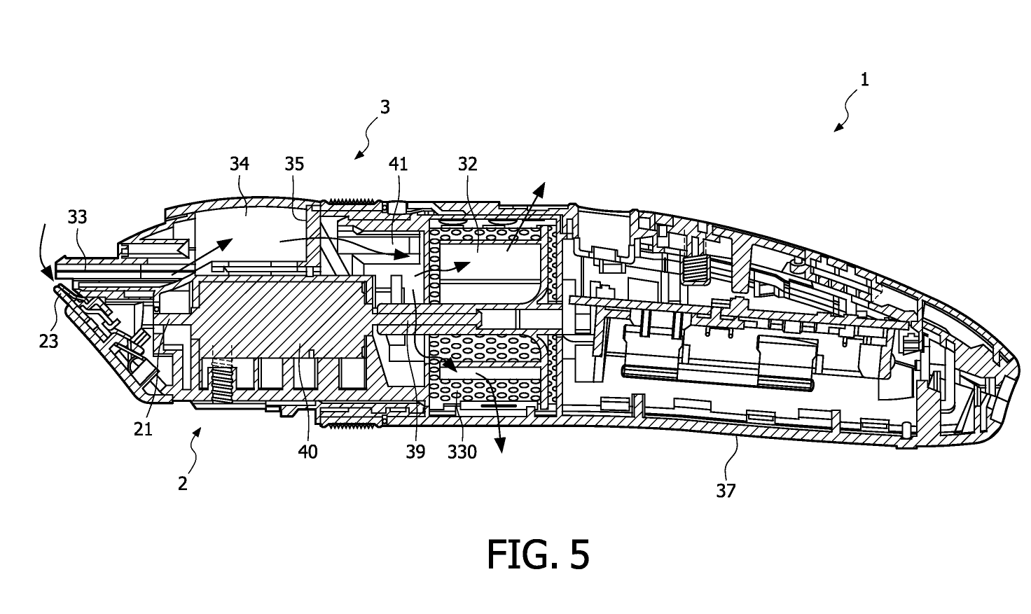

FIG. 5 shows that the concept described above can as well be adapted to a beard trimmer 1 having only one motor 40 for driving the blades 23 as well as the fan 32. To this end, the motor 40 presents a first spindle to drive the blades 23 and a second spindle 39 to drive the fan 32. The beard trimmer 1 of FIG. 5 is simpler to produce and has a lower energy consumption. But there are several drawbacks. One is that the beard trimmer is much louder when operating at high suction power than the two-motor embodiments, because the blades moving at high speed are quite noisy. Then, as explained above, the providable suction power is limited by the fact that the cutting efficiency gets worse with high speeds. Furthermore, the beard trimmer cannot be used, if the motor 40 breaks down, while a beard trimmer with two motors, where only the fan motor 30 broke can still be used.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 beard trimmer
2 cutting unit
20 motor
21 spindle
22 shaft
23 blades
24 gearing
3 suction unit
30 motor
31 spindle
32 radial fan
32a,b radial fan
320 vane
321 adaptor
322 bottom
323 lid
33 air intake
33a,b air intake
330 air exhaust
34 receptacle
35 filter
36 input
37 output
38 gearing
39 spindle
39a,b spindle
4 battery
40 motor
41 intermediate chamber
51 switch
52 switch
61 lamp
62 lamp
7 casing

1. A hair trimmer (1) comprising:
a cutting unit (2) for trimming hair driven by a first motor (20),
a suction unit (3) for absorbing clippings that is driven by a second motor (30),
characterized in that the second motor (30) is operable to function in at least two different modes, one of the modes resulting in a lower suction power and the other of the modes resulting in a higher suction power.

2. The hair trimmer according to claim 1, characterized in that the suction unit (3) comprises a fan (32, 32a, 32b) that is driven by the second motor (30).

3. The hair trimmer according to claim 2, characterized in that the second motor (30) is operable at different values of revolutions per minute.

4. The hair trimmer according to claim 2, characterized in that the suction unit (3) comprises two radial fans (32a, 32b) that are driven by the second motor (30).

5. The hair trimmer according to claim 2, characterized in that it comprises a receptacle (34) to collect hair clippings, this receptacle (34) being arranged in suction direction before the fan (32).
